(19) United States
(12) Patent Application Publication
(10) Pub. No.: US 2005/0144801 A1
(43) Pub. Date: Jul. 7, 2005

(54) Portable battery operated floor drying apparatus

(76) Inventor: Thomas Henry Wilson, Kirkwood, IL (US)

Correspondence Address: Thomas H. Wilson Jr., 1659 Tenth Street, Kirkwood, IL, 61447, US

(21) Appl. No.: 10/746,006

(22) Filed: Dec. 26, 2003

(51) Int. Cl. F26B 19/00; F26B 25/06

(52) U.S. Cl. 34/60; 34/90

(57) ABSTRACT

A dryer (10) is disclosed for drying hard floor surfaces. The fan (18) is integrated with a bucket (32) and wringer (30) forming a unitary structure. The unit contains an onboard power supply and charging system. The unit further incorporates a platform (15) to secure bucket (30). Still further the device is fitted with a brake (20) to secure the unit in place during operation and wheels (12) for easy transportation.

### FEDERALLY SPONSORED RESEARCH

Not Applicable

### SEQUENCE LISTING OR PROGRAM

Not Applicable

### BACKGROUND—FIELD OF THE INVENTION

This invention relates generally to air dryers, and more particularly to a motor driven centrifugal fan used to dry hard floor surfaces.

### BACKGROUND—DESCRIPTION OF PRIOR ART

Public buildings such as grocery stores, supermarkets, airports, hospitals, nursing homes, and all other establishments that possess hard surface floors, must on numerous occasions contend with liquid spills. Such spills must be removed as quickly as possible to maintain safe conditions for employees, customers, and visitors.

To date, the most widely used methods of addressing unsafe and unsightly spills have been to remove the spills with a mop used in conjunction with a bucket and ringer, or to use machines of various types to vacuum up spills; all of which will leave the surface, of the then cleaned area, with a film of moisture that still results in a slippery area. Through the years many attempts have been made to implement traffic control devices that will protect pedestrians from slippery floor conditions. These devices include, but are not limited to, barricades, caution tape, and wet floor signs of many types. All have been employed at and around affected areas in an effort to warn of unsafe conditions as well as to impede the progress of pedestrians that could injure themselves by falling due to the slippery condition of a floor.

One of the surest ways to defeat the problem of a liquid film being left behind is to force high velocity streams of air over the surface of the floor in order to quickly evaporate any residue. One major issue surrounding the use of an air moving device capable of delivering the air capacity needed to dry an area in a timely fashion, is the need for a power cord that in turn provides an additional hazard. This is due to the fact, that a person's feet can easily become entangled, causing that person to trip and possibly injure him or herself. A second problem associated with most air movers, is that they are only slightly larger than the diameter of the fan assembly itself. This causes the apparatus to carry a low silhouette that is easy to overlook and therefore stumble over.

### OBJECTS AND ADVANTAGES

Accordingly several objects and advantages of the present invention are:
(a) to provide a floor drying apparatus that will facilitate the evaporation of water on hard surface floors by using high velocity air;
(b) to provide a floor drying apparatus that is easily transportable to affected areas;
(c) to provide a floor drying apparatus that contains its own power supply and power recovery system;
(d) to provide a floor drying apparatus that integrates the advantages of a centrifugal fan, and a bucket-ringer combination;
(e) to provide a floor drying apparatus that can be brightly colored to serve as a safety icon;
(f) to provide a floor drying apparatus that carries a high silhouette that can be readily seen;
(g) to provide a floor drying apparatus that allows for a rack upon which to hang additional warning signs or barriers;
(h) to provide a floor drying apparatus that can be fitted with recording hardware to announce verbal warnings;
(i) to provide a floor drying apparatus that can be fitted with a motion detector to activate a horn and or, audio warnings;
(j) to provide a floor drying apparatus that can be fitted with a warning light to provide additional visual warning;
(k) to provide a floor drying apparatus that has a braking mechanism to secure its position;

Further objects and advantages are to provide a floor drying apparatus that allows an individual to transport an air mover, a bucket and ringer, floor signs, cleaning solution, and power supply to an affected area in one trip. This helps to facilitate a more rapid clean up of spills and subsequently, less danger to pedestrians.

### SUMMARY

In accordance with the present invention, the portable battery operated floor drying apparatus comprises a bucket and ringer, an air mover, an on board power supply with recovery system, various audio and visual warning devices, and a braking mechanism accommodated by or incorporated into a moveable platform.

### DRAWINGS

### Drawing Figures

In the drawings, closely related figures have the same number but different alphabetic suffixes. Alphabetic suffixes of drawing figures are demonstrated in upper case while individual parts are demonstrated in lower case.

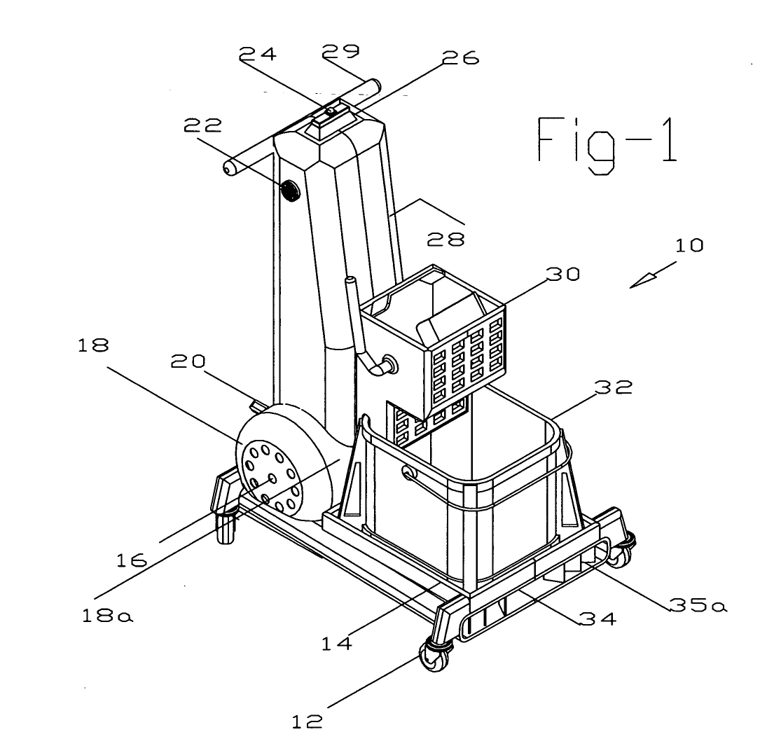

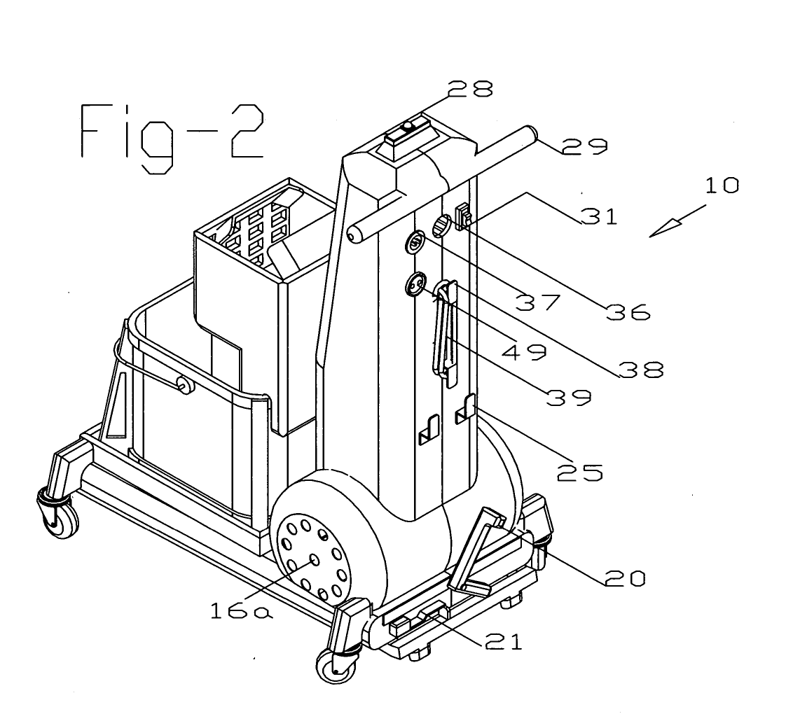

FIG. 1 is an isometric view of the present invention's exterior components.

FIG. 2 is an isometric view of the present invention from the rear perspective.

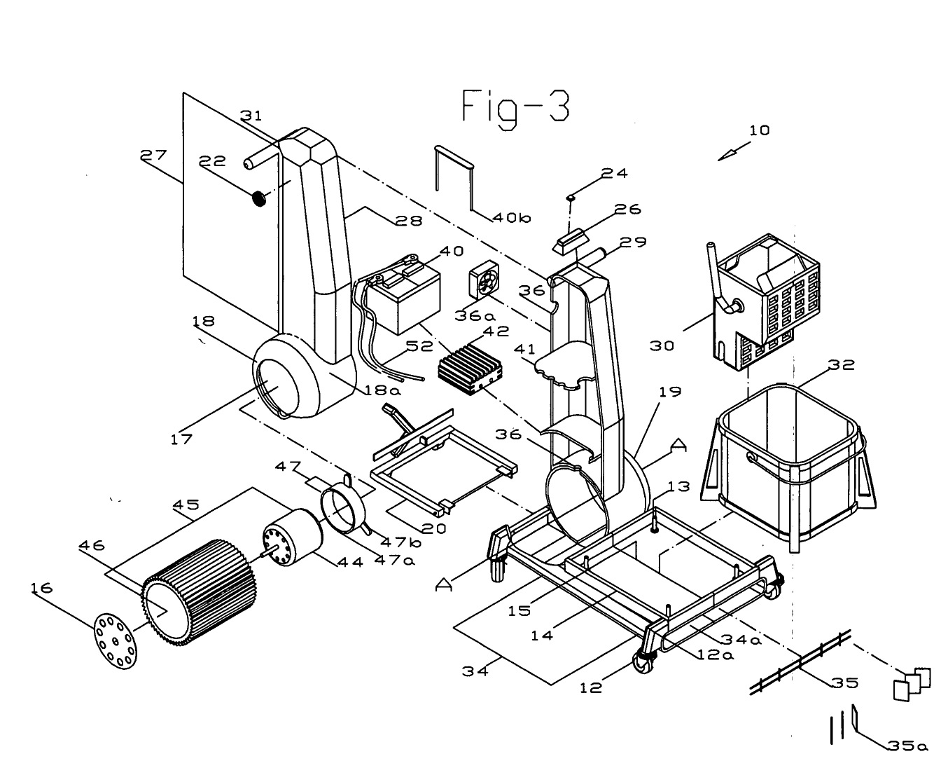

FIG. 3 is an exploded view of the present invention's component parts.

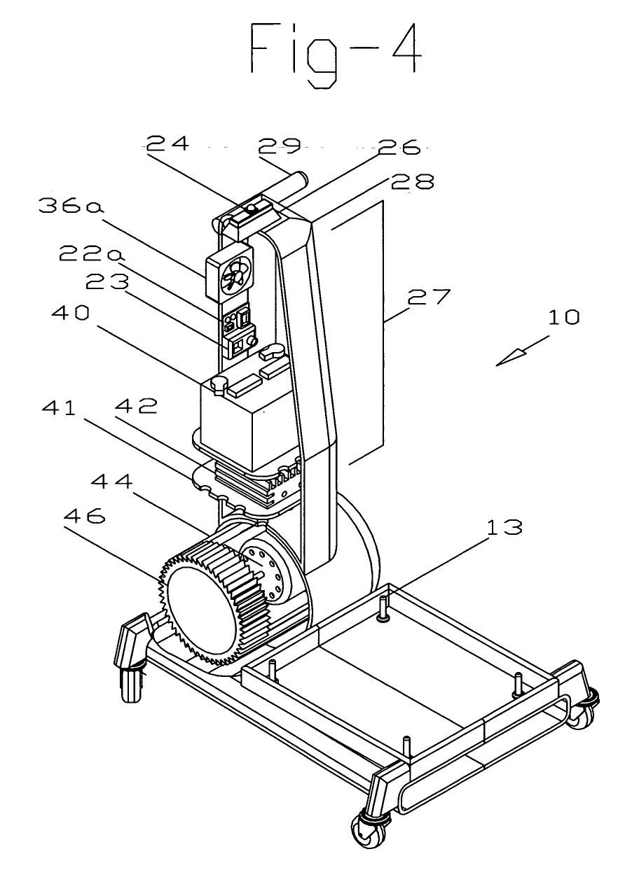

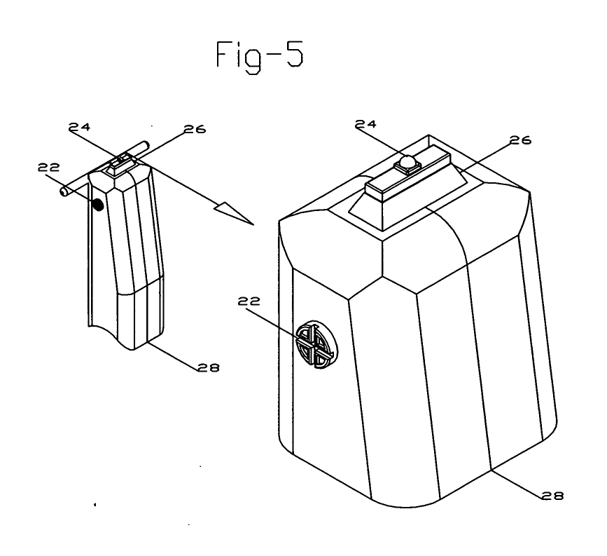

FIG. 4 is an isometric view of the present invention with battery, charger and low volt dc motor shown.

FIG. 5 is an isometric view of the hood with audible warning device, light and motion detector attached.

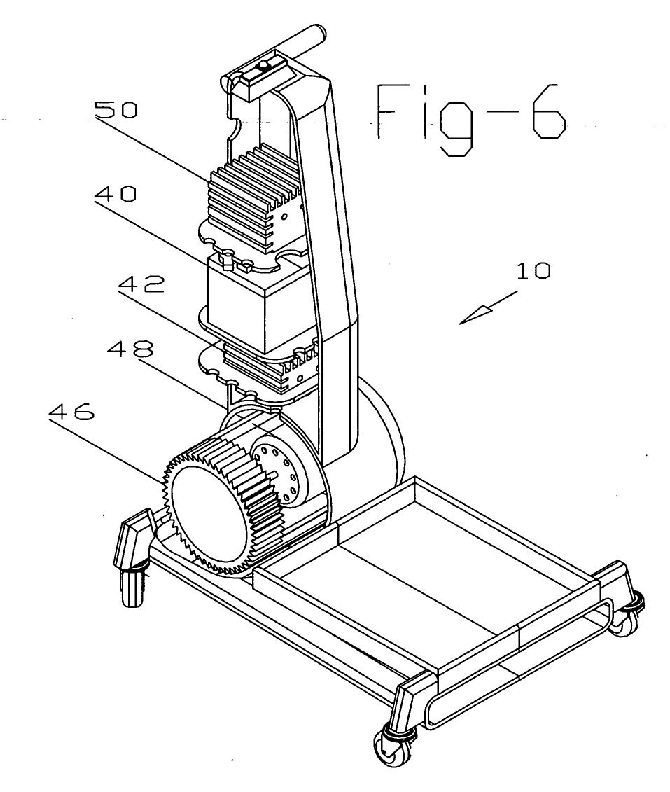

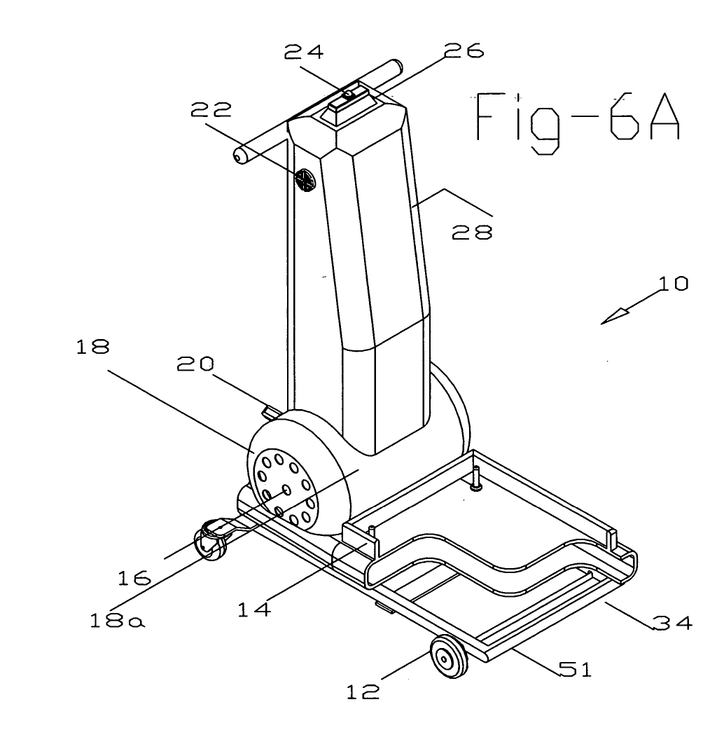

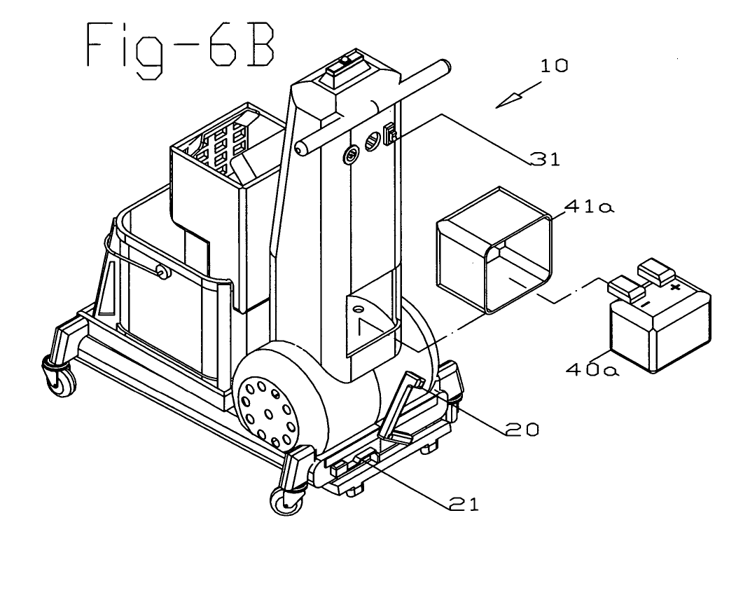

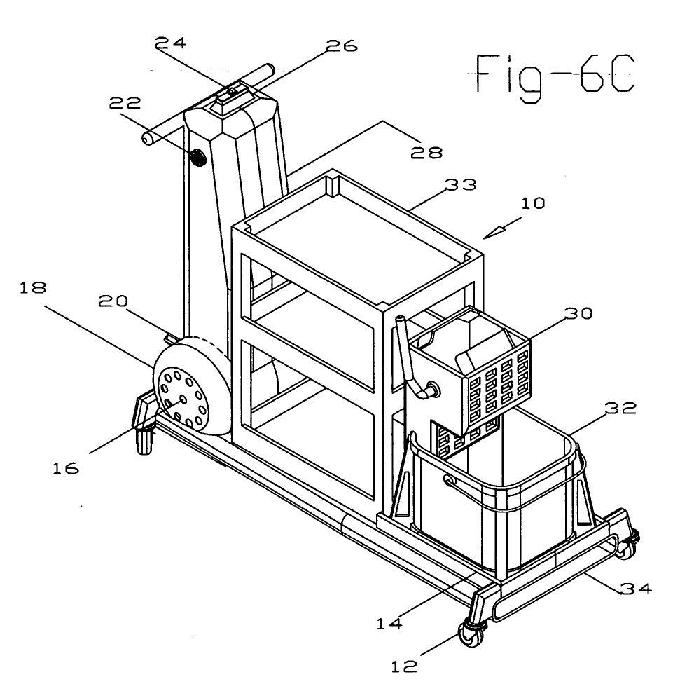

FIG. 6 is a cut-away view of the present invention with the power inverter, an AC motor, and a battery charger shown.

FIG. 6A is an isometric view of the present invention illustrating an alternative, wheel and bracket mounting method; illustrated as a sub-carriage.

FIG. 6B is an isometric view of the present invention illustrating an alternative compartment, manufactured to accommodate an interchangeable battery.

FIG. 6C is an isometric view of the present invention showing the dryer with an extended platform to accommodate the addition of a janitorial cart.

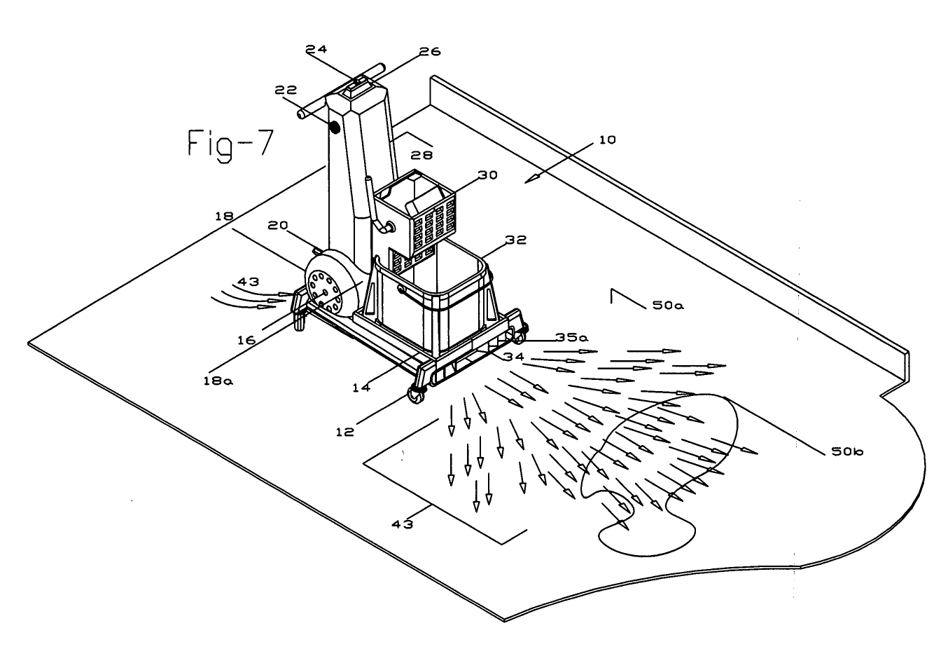

FIG. 7 is an isometric view illustrating the operation of the dryer described in the preferred embodiment.

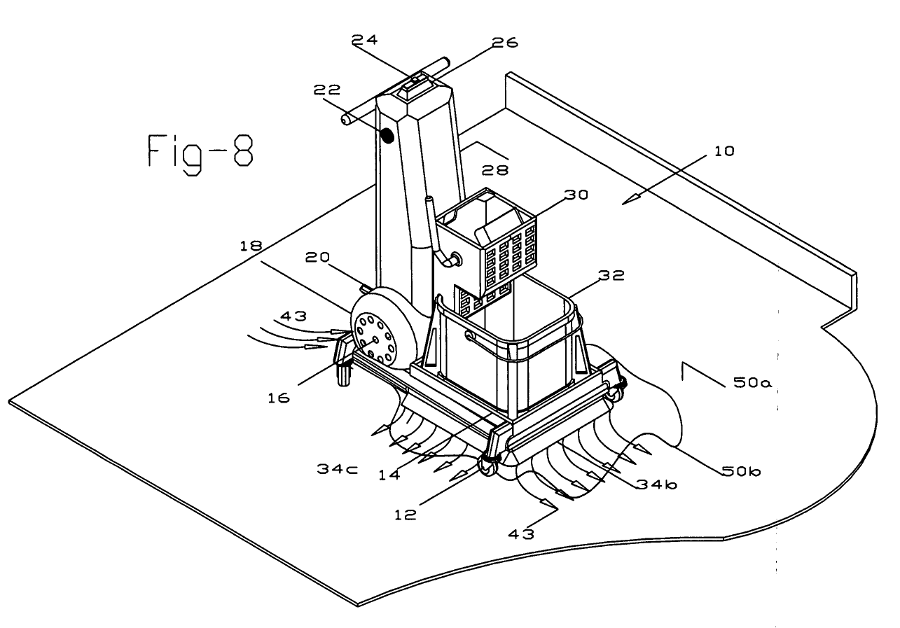

FIG. 8 is an isometric view of an alternative embodiment illustrating the dryer as a closed end unit with the air stream directed downward over the spill.

### REFERENCE NUMERALS IN DRAWINGS

| | |
|---|---|
| 12 | casters |
| 13 | locator pins |
| 14 | fence |
| 15 | platform |
| 16 | vented covers |
| 17 | open end |
| 18 | fan housing |
| 18a | cylindrical portion |
| 19 | open end |
| 20 | brake |
| 21 | safety switch |
| 22 | horn |
| 22a | recording hardware |
| 23 | timing mechanism |
| 24 | motion detector |
| 25 | battery hooks |
| 26 | light |
| 27 | power station |
| 28 | hood |
| 29 | handle |
| 30 | mop ringer |
| 31 | switch |
| 32 | mop bucket |
| 33 | cart |
| 34 | outlet portion |
| 34a | outlet |
| 34b | louver |
| 34c | underside outlet |
| 35 | grate |
| 35a | directional vent |
| 36 | cooling vents |
| 36a | cooling fan |
| 37 | external AC plug |
| 38 | cord winding |
| 39 | power cord |
| 40 | battery |
| 40a | interchangeable battery |
| 40b | tie down |
| 41 | component rack |
| 41a | battery cradle |
| 42 | battery charger |
| 43 | air movement arrows |
| 44 | DC motor |
| 45 | blower apparatus |
| 46 | fan |
| 47 | motor mount |
| 47a | circular flange |
| 47b | extending struts |
| 48 | AC motor |
| 49 | external DC plug |
| 50 | power inverter |
| 50a | floor surface |
| 50b | liquid spill |
| 51 | carriage |

### DETAILED DESCRIPTION

### Description—FIGS. 1, 2, 3, 4 and 5—Preferred Embodiment

Referring to the drawings wherein the showings are for the purposes of illustrating a preferred embodiment of the present invention only, and not for the purposes of limiting the same, FIG. I illustrates the exterior components, FIG. 2 illustrates the reverse view of FIG. 1, FIG. 3 illustrates an exploded view, FIG. 4 illustrates a cut away of the hood 28 to show components, and FIG. 5 illustrates safety components.

Referring now to the isometric view of the floor dryer 10 shown in FIG. 1, in known fashion the fan portion of the dryer 10 is generally comprised of a housing 18 which includes a cylindrical portion 18a and an air outlet portion 34. Housing 18 is preferably molded or otherwise constructed from a suitable plastic or other lightweight material. Cylindrical portion 18a is constructed so as to include a hollow interior portion having a first open end 17 (FIG. 3) and a second open end 19 (FIG. 2) on each end thereof. First open end 17 and second open end 19 are axially aligned along axis A-A and are adjusted to receive air through vented covers 16 (FIG. 3) and 16a (FIG. 2) for the operation of the dryer 10. Disposed within the interior of cylindrical portion 18a along axis A-A is an air blower apparatus 45, which is shown in an exploded view in FIG. 3. Blower apparatus 45 primarily comprised of a motor 44 and a fan 46. A motor mount 47 is used to attach motor 44 to cylindrical portion 18a. Motor mount 47 comprises a circular flange 47a used to secure the cylinder portion of the motor 44, and outwardly extending struts 47b to fasten to housing 18a cylindrical portion in known fashion, illustrated in FIG. 3.

In the preferred embodiment of the present invention the air is discharged from dryer 10 through outlet portion 34 of housing 18. Outlet portion 34 defines a generally elongated opening, which extends in molded form, distally to create a platform 15 (FIG. 3) designed to accommodate a bucket 32. Outlet portion 34 then terminates in outlet 34a. Contained within outlet 34a is a grate 35 comprised of interconnected horizontally and vertically disposed members. Grate 35 functions as a support as well as aids in preventing large objects from entering outlet portion 34 shown in FIG. 3. Recessed within outlet 34a is a plurality of directional vents 35a that function as further support of platform 15 and direct air movement.

Referring again to FIG. 3, platform 15 forms the top portion of outlet portion 34, and is coupled with a raised fence 14 to retain spill over from bucket 32. Mounted or molded on platform 15 and within the perimeter of fence 14 are locator pins 13; for use in positioning bucket 32. In known fashion a conventional mop ringer 30 is nested atop bucket 32. FIG. 3 further illustrates the approximate position and number of wheels 12 as well as molded mounting brackets 12a. The number, size, type, and mounting method of wheels 12 and brackets 12a are such as to prevent the dryer from being easily overturned, as is generally understood by those skilled in the art.

In the preferred embodiment of the present invention (seen in FIG. 4) a power station 27 is required. Station 27 is comprised of a vertically or horizontally mounted component rack 41, and a removable hood 28 that provides a shield for the electronic components contained therein. Disposed within station 27 is a power supply, comprised of a battery, or batteries 40 with the capacity to activate an assigned electric motor 44 being connected to fan 46. As is known, a low voltage direct current motor is best suited for this purpose. The size and voltage rating of motor 44 is determined by those skilled in the art. Further disposed within station 27; is a timing mechanism 23, verbal recording hardware 22a, electrically activated cooling fan 36a (FIG. 3), and a battery charger 42 that possesses a power cord 39(FIG. 2) for attachment to a standard 110 volt outlet. As is understood to those skilled in the art, on-board electronics are wired in known fashion via electric conductors, to the proper components to facilitate recharge of the power supply (battery 40).

Referring still to FIG. 4 of the present invention, hood 28 of station 27, is in known fashion, equipped with cooling vents 36. Cooling vents 36 are illustrated and employed in various locations of hood 28 and fan housing 18a, to assist in cooling electronic components contained there in.

Referring now to FIG. 2, hood 28 allows for positions that facilitate the mounting of a maneuvering handle 29, a cord winding assembly 38, on/off switch 31, auxiliary battery hooks 25, external DC plug 49, and an external AC plug 37. In the preferred embodiment of the present invention a conventional back-up battery, conventional back-up external charger, and supplementary extension cord are not shown, though it is understood that each component is mated to dryer 10 via the appropriate AC or DC connection points.

Referring still to FIG. 2 a brake mechanism 20 is attached to floor dryer 10 in conjunction with a safety switch 21.

The preferred embodiment of the present invention contains various safety-related components. FIG. 5 illustrates both audio and visual warning devices mounted to hood 28. With appropriate switches known to those skilled in the art, a flashing light 26 can be activated alone, or in unison with motor 44 during the drying process. Referring further to FIG. 5, a motion detector 24 is wired so as to activate an auditory device 22 such as a horn, beeper or recorded message 22a. Such auditory devices are employed to supplement visual safety measures.

Additional modifications and improvements of the invention may also be apparent to those skilled in the art, thus, the particular combination of parts described and illustrated herein is intended to represent one embodiment of the invention, and is not intended to serve as limitations of alternative devices within the spirit and scope of the invention as defined by the claims which follow.

### Operation of Preferred Embodiment—FIGS. 2, 3 and 7

Next, an operation of the portable battery operated floor drying apparatus will be described below.

As shown in FIGS. 2, 3 and 7, dryer 10 is moved by an operator who uses handle 29 to push the unit to the desired location upon wheels 12. As seen in FIG. 7, dryer 10 is positioned near the edge of a spill 50b. The operator then engages brake 20 to secure dryer 10. Engaging brake 20 (FIG. 2) releases safety switch 21, while simultaneously preventing blower 10 from recoiling due to directionally propelled air masses during operation. The operator then has the option of applying power to motor 44 by activating switch 31 in order to gain a head start on the evaporation process, or to begin mopping the spill with a conventional mop (not shown).

Throughout the operating procedure of the preferred embodiment, the operator is understood to have removed the spilled material prior to dryer 10 operation. After the affected area has been cleared of spilled material in known fashion; the operator then has the option of repositioning dryer 10 to the center of the now cleaned area before applying power to dryer 10 by actuating switch 31(FIG. 2). As is understood, during operation of dryer 10, air is drawn into fan housing 18 through vented covers 16 and 16a. Adequate volumes of air are pulled through blower apparatus 45 (FIG. 3) as motor 44, in known fashion, rotates fan 46 at high speed. Forced rotation of fan 46 propels large quantities of air through directional vents 35a located in outlet 34a. As air is forced past directional vents 35a, resultant horizontal wind columns are dispersed over the floor surface at varying degrees, as indicated by arrows 43. Subsequently, the forced volumes of air movement over the residual liquids facilitates their rapid evaporation.

In conjunction with the enabled motor 44, safety light 26 commences flashing as a visual warning. Motion detector 24 is activated to act as a signal switch for horn 22 and recording hardware 22a. Also, with the activation of motor 44; a timing mechanism 23 begins a preset countdown that terminates the operation of dryer 10 and component parts; thus, promoting power conservation.

With the termination of power to dryer 10 by timing mechanism 23, or at any time earlier, the operator is free to move the unit to another location. At such time, that the operator deems necessary, or the power drain is sufficient to render the unit inoperable, dryer 10 is moved to a convenient location having a power outlet.

Cord 39 being connected to charger 42, is then removed from winding 38 and connected to the proper alternating current power source to begin the recharge process of battery 40.

### FIGS. 6, 6A, 6B and 6C—Additional Embodiments

Additional embodiments are shown in FIGS. 6, 6A, 6B, and 6C; in each case the components of the preferred embodiment are illustrated in conjunction with the modifications and additional components.

### Embodiment—2—FIG. 6

FIG. 6 floor dryer 10 is fitted with a power inverter 50 and an AC motor 48.

### Operation of Additional Embodiment—2

Operation of dryer 10 illustrated in FIG. 6 follows the identical procedures described in the operation of the preferred embodiment.

### Embodiment—3—FIG. 6A

FIG. 6A, floor dryer 10 is fitted with an under carriage 51, thus allowing for conventional brackets (not shown) to be welded or bolted on to accommodate various options.

### Operation of Additional Embodiment—3

Operation of dryer 10 illustrated in FIG. 6A follows the identical procedures described in the operation of the preferred embodiment.

### Embodiment—4—FIG. 6B

FIG. 4A power station 27 is no longer fitted with a integral battery and charger. Station 27 illustrated in FIG. 4A is manufactured to accept an interchangeable battery 40a that possesses the proper conventional quick disconnect hardware to allow for rapid battery removal and installation.

### Operation of Additional Embodiment—4

Operation of dryer 10, illustrated in FIG. 4A follows the identical procedures described in the operation of the preferred embodiment with exception to, battery charging actions. Operational procedure for this embodiment requires the operator to remove battery 40a from a battery cradle 41a, with a pulling motion. Battery 40a is then connected to a conventional charger (not shown). The operator must then insert a charged, supplementary battery (not shown); or wait for the previously removed battery 40a to recharge in order to resume cordless operation of the unit.

### Embodiment—5—FIG. 6C

FIG. 6C outlet portion 34 of floor dryer 10 is extended and is fitted with an industry known janitorial cart 33. Conventional janitorial supplies and instruments are not shown.

### Operation of Additional Embodiment—5

Operation of dryer 10, illustrated in FIG. 6C follows the identical procedures described in the operation of the preferred embodiment.

### FIG. 8—Alternative Embodiment

Referring now to the isometric view of dryer 10 shown in FIG. 8, all components are a duplication of the preferred embodiment illustrated in FIG. 1, with exception to the various possibilities for air movement, direction and expulsion.

FIG. 8 shows outlet portion 34 to no longer be open at the most distal position, as previously illustrated in the preferred embodiment (FIG. 1). FIG. 8 shows outlet portion 34 of dryer 10 as opened on the bottom side to form underside outlet 34c. Contiguous with the vertical sides, and distal end of outlet portion 34, is louver 34b. Louver 34b wraps the perimeter of outlet 34c, being set at an angle that forces air to move along the floor away form dryer 10.

Disposed on the under side of platform 15 is a plurality of conventional directional vents, not shown as design, placement, and number are understood to those skilled in the art.

### Operation of an Alternative Embodiment—FIG. 8

Next, a second operation of the portable battery operated floor drying apparatus will be described below.

Operation of dryer 10, illustrated in FIG. 8 follows the identical procedures described in the operation of the preferred embodiment, with exception to placement of the unit. After mopping the spilled area, the operator maneuvers dryer 10 over the center of the now cleaned area, as illustrated in the drawing FIG. 8. Arrows 43 indicate the direction of the air streams.

### ADVANTAGES

From the description above, a number of advantages of my portable battery operated floor-drying apparatus become evident:
(a) Moving forced streams of air over areas that have been spilled upon will expedite the evaporation of liquid residue left behind after mopping.
(b) By mounting wheels to the underside of the dryer housing, one can move the dryer to various locations inside a building with relative ease.
(c) With the installation of an onboard power supply and power recovery system, one can eliminate the need for dangerous electrical cords that need to be laid out across the floor to be connected to a power source.
(d) By integrating a fan, and a bucket-ringer combination into one unit, time will be saved by only having to make a single trip to the affected area with the equipment need to remove a spill and then dry it quickly.
(e) The use of brightly colored plastics in the molding process will produce a floor dryer housing that will be highly visible, thus allowing the whole unit to serve as a safety icon.
(f) By providing an apparatus that carries a high silhouette that can be readily seen, instances of tripping over the unit can be eliminated.
(g) The hood of the power station can be fitted with mounting brackets for use in securing additional warning devices, such as wet floor signs, barricades, and caution reels.
(h) The presence of a horn or beeper, recording hardware, and motion detector will permit the unit to emit audible warnings to persons in the vicinity.
(i) The installation of a flashing light will complement all other safety measures surrounding the dryer by calling attention to the unit from a distance.
(j) With the use of the attached braking mechanism, the unit can be reasonably secured to the area determined by the operator.

### CONCLUSION, RAMIFICATIONS, AND SCOPE

Accordingly, the reader will see that the portable battery operated floor-drying apparatus of this invention, provides a unit that can be used to speed the evaporation of residual liquids of a cleaned area. Furthermore, the floor drying apparatus has additional advantages in that
it provides mounting points for wheels, which enable the dryer to be transported to various locations inside a building with relative ease.
it provides a station for single or multiple batteries that can deliver power, thus eliminating dangerous electrical cords that need to be laid out across the floor to be connected to a power source;
it provides a position for a battery charger; that can be of various sizes while providing various charging options and components;
it provides a fan, and a bucket-ringer combination in one unit, and can save time by necessitating only a single trip to the affected area with the equipment needed to remove a spill and then dry it quickly.
it provides a housing that can be made of highly visible, brightly colored plastics, thus allowing the whole unit to serve as a safety icon.
it provides an apparatus that carries a high silhouette that can be readily identified, thus instances of tripping over the unit can be eliminated;
it provides a removable hood that can be fitted with mounting brackets for use in securing additional warning devices, such as wet floor signs, barricades, and caution reels.
it provides locations for various sizes and designs of recording devices, horns, beepers, which can be tied to motion detectors that will permit the unit to emit audible warnings to persons in the vicinity.
it provides a position for numerous types of flashing lights that can complement all other safety measures surrounding the dryer by calling attention to the unit from a distance.
it provides a dryer with an attached braking mechanism, thus allowing the unit to be reasonably secured to the area determined by the operator.

While the above description contains many specificities, these should not be construed as limitations on the scope of the invention, but rather as an exemplification of one preferred embodiment thereof. Many other variations are possible. For example, multi-directional fans can be employed to send air currents in all directions, mechanically or electrically oscillated air vents can be placed on board to swing air currents, a transmitter can be placed on board to signal flashing lights placed at the end of isles to offer further warnings of danger in that area.

Accordingly, the scope of the invention should be determined not by the embodiment(s) illustrated, but by the appended claims and their legal equivalents.

1. A portable battery operated floor drying apparatus henceforth, described as a dryer, having a housing including an air inlet portion, a blower chamber portion, and an air outlet portion and a blower disposed within said blower chamber portion to draw air into said inlet portion and discharge the air through said outlet portion at a high velocity, said blower including a generally cylindrical motor rotatably connected to a fan and attached to said housing by at least one strut;
a power station and a means of connection, to at least one part of said housing, said power station comprises at least one battery, being connected by electric conductors to said motor via a switch mechanism

2. The portable dryer of claim 1 further including:
a platform, whereby a conventional bucket is positioned.

3. The portable dryer of claim 2 further including:
A plurality of dowel shaped pins wherein, said pins are mounted in the vicinity of said platform in a vertical orientation with the distal end of said pins being positioned so as to mate with the underside of said bucket as a means for locating said bucket into position.

4. The portable dryer of claim 2 further including:
an extended platform wherein said platform further accommodates a known janitorial cart.

5. The portable dryer of claim 2 further including:
a platform whereby said outlet portion is open to the underside of said platform, thus providing a means for guiding forced air currents in a downward direction.

6. The portable dryer of claim 2 further including:
a fence comprised of vertically orientated members disposed atop said platform wherein said members form a perimeter about the base of said bucket thereby serving as a barrier in opposition to liquid over spill from said bucket.

7. The portable dryer of claim 1 further including:
a means for providing a cradle and a quick disconnect means disposed within said power station whereby an interchangeable battery can be used.

8. The portable dryer of claim 1 further including:
a means of moving and securing the portable dryer utilizing at least two wheels attached rotatably in an orientation wherein said wheels provide a means for moving said dryer to various locations and a mechanical restraint device, whereby, said dryer is secured in position;

9. The portable dryer of claim 8 further including:
a switch attached to said mechanical restraint device wherein, said switch being of the type that is activated in conjunction with said restraint device to enable and terminate power to said motor.

11. The portable dryer of claim 1 further including:
a carriage utilizing at least two wheels attached rotatably in an orientation wherein said wheels provide a means for moving said dryer to various locations and providing a means for further mounting optional brackets for accessory items, still further said carriage being attached by at least one point to said housing.

12. The portable dryer of claim 1 further including:
a device for converting direct electrical current into alternating electrical current whereby said motor, being of the alternating electrical current type, is powered by said battery or an external alternating current source.

13. The portable dryer of claim 1 further including:
an auditory warning means comprising at least one auditory device producing at least one type of audible warning, said auditory device being activated by at least one motion detecting device whereby said auditory device commences generating said warning.

14. The portable dryer of claim 1 further including:
at least one luminous device of the flashing type, whereby said device generates a visually conspicuous means for drawing attention to said dryer.

15. The portable dryer of claim 1 further including:
at least one timing mechanism as a means for terminating power to predetermined components contained therein.

16. The portable dryer of claim 1 further including:
a power subsidizing means comprising an external battery coupled with said power station through a direct current receptacle, for the purpose of extending operation time of said dryer between charging cycles and a means for securing said external battery to said power station.

17. The portable dryer of claim 1 further including:
a means for generating cooling winds whereby components contained within said power station, are given the advantage of having heat dissipating air streams pass by.

18. The portable dryer of claim 1 further including:
directional vents as a means for conducting air expelled from said dryer at various angles, whereby air movement covers a path extending beyond the width of said dryer.
